(19) United States
(12) Patent Application Publication
(10) Pub. No.: US 2025/0010651 A1
(43) Pub. Date: Jan. 9, 2025

(54) METALLIC SHEET WITH SECURITY WINDOW AND METHODS OF MANUFACTURE

(71) Applicant: Valaurum, Inc., Portland, OR (US)

(72) Inventor: Adam Trexler, Portland, OR (US)

(73) Assignee: Valaurum, Inc., Portland, OR (US)

(21) Appl. No.: 18/896,336

(22) Filed: Sep. 25, 2024

Related U.S. Application Data
(63) Continuation of application No. 17/731,500, filed on Apr. 28, 2022.

(30) Foreign Application Priority Data
Nov. 2, 2023 (WO) PCT/US2023/020221

(51) Int. Cl. B42D 25/351; B42D 25/324; B42D 25/328; B42D 25/355; B42D 25/373; B42D 25/378; B42D 25/45

(52) U.S. Cl. CPC B42D 25/351; B42D 25/45; B42D 25/324; B42D 25/328; B42D 25/355; B42D 25/373; B42D 25/378

(57) ABSTRACT

A security note may include a first transparent substrate having an area that defines boundaries of the security note. The note may include a first base layer deposited on the first transparent substrate. The note may include a second base layer deposited on the first base layer. The note may include a second transparent substrate formed on the second base layer. One or more security features may be provided between the first base layer and the second base layer. One or both of the first base layer and the second base layer may define an opening within the area of the first transparent surface such that at least one of the one or more security features is visible via the opening.

### CROSS-REFERENCES TO RELATED APPLICATIONS

This application is a continuation of International Application No. PCT/US2023/020221 by Trexler, entitled “METALLIC SHEET WITH SECURITY WINDOW AND METHODS OF MANUFACTURE,” filed Apr. 27, 2023, which claims priority to U.S. application Ser. No. 17/731,500 by Trexler, entitled “METALLIC SHEET WITH SECURITY WINDOW AND METHODS OF MANUFACTURE,” filed Apr. 28, 2022, the entire disclosures of which are hereby incorporated by reference, for all purposes, as if fully set forth herein.

### BACKGROUND OF THE INVENTION

There is an ever-growing need for increased data security and authentication techniques, especially with the ever-evolving state of computer technology. This is particularly true when dealing with currency, financial instruments, and electronic transactions. Some of these areas utilize some physical manifestation of a currency or payment to facilitate acquiring, owning and transferring financial value. Typically, these physical manifestations of value include at least one security feature. Conventionally, security features of this nature are in the form of stickers, such as holographic stickers or scratch-off materials that, when removed, expose some authentication data. However, such security features themselves include inherent security risks, as stickers may be easily removed and/or replaced and scratch-off materials may be easily tampered with by sophisticated users. Numerous other problems exist with conventional security features. Therefore, improved security features are desired.

### BRIEF SUMMARY OF THE INVENTION

In one embodiment, a security note is provided. The security note may include a first transparent substrate having an area that defines boundaries of the security note. The note may include a first base layer deposited on the first transparent substrate. The note may include a second base layer deposited on the first base layer. The note may include a second transparent substrate formed on the second base layer. One or more security features may be provided between the first base layer and the second base layer. One or both of the first base layer and the second base layer may define an opening within the area of the first transparent surface such that at least one of the one or more security features is visible via the opening.

In some embodiments, at least one peripheral edge of the opening extends to an edge of the first transparent substrate. An entire periphery of the opening may be disposed inward of the boundaries of the security note. The one or more security features may include one or more feature selected from the group consisting of: a public encryption key, a private encryption key, a hologram, color change ink, color change adhesive, a human readable feature, a computer readable feature, a printed security image, a code, a serial number, an information feature, a layer of gold having a thickness of less than about 200 nm, a relief structure, and a personal identification number (PIN). The opening may form a border that extends around the boundaries of the security note. The note may include security data provided between solid portions of the first base layer and the second base layer such that the security data is not visible or detectable from an outside the security note. The security note may be configured to be de-laminated to irreversibly separate at least some layers of material of the security note to expose the security data. The de-lamination may cause irreversible damage to one or more layers of material on either side of the security data. The irreversible damage may include one or more of the group comprising: turning one or both of the first base layer and the second base layer into flakes, turning one or both of the first base layer and the second base layer into a powder, folding the security note, creasing the security note, breaking of one or more print layers, breaking of one or more security threads, oxidation of one or more layers of the security note, separation of one or more print layers into distinct surfaces of layers of the security note, intentional tearing of one or more layers of the security note, a color change of an adhesive layer, and a de-metallization of a hologram. The note may include a third base layer disposed between the first base layer and the one or more security features. The note may include a fourth base layer disposed between the second base layer and the one or more security features. The opening may include distinct sections. At least two of the distinct sections may include different security features. Each of the first base layer and the second base layer define a respective opening that are at least partially aligned with one another such that at least a portion of the security note is see through.

In another embodiment, a method of producing a security note is provided. The method may include depositing a first base layer on a first transparent substrate. The first transparent substrate may have an area that defines boundaries of the security note. The method may include depositing a second base layer on the first base layer. The method may include applying a second transparent substrate to the second base layer. The method may include providing one or more security features between the first base layer and the second base layer. The method may include forming an opening within one or both of the first base layer and the second base layer such that at least one of the one or more security features is visible via the opening.

In some embodiments, forming the opening may include one or more of removing a portion of the first base layer, removing a portion of the second base layer, forming the opening by a deposition pattern of the first base layer, forming the opening by a deposition pattern of the second base layer, and using a masking procedure to define the opening. One or both of removing the portion of the first base layer and removing the portion of the second base layer may include one or more procedures selected from the group consisting of: abrading of material, laser etching of material, and acid removal of material. The method may include instantiating security data onto at least one layer of the security note such that the security data is not visible or detectable from outside the security note. The security note may be configured to be de-laminated to irreversibly separate at least some layers of material of the security note to expose the security data. The de-lamination may cause irreversible damage to one or more layers of material on either side of the security data. In some embodiments, no adhesive is applied over the security data. Providing the one or more security features may include forming a hologram on one or both of the first transparent layer or the first base layer. One or both of the first base layer and the second base layer may be applied via vacuum disposition. One or both of the first base layer and the second base layer may be applied via magnetron sputtering. The method may include providing a blocking layer on one or both sides of the one or more security features. Forming the opening may include one or both of removing a portion of the first transparent layer and removing a portion of the second transparent layer.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a set of parentheses containing a second label that distinguishes among the similar components. If only the first reference label is used in the specification, the description is applicable to any one of the similar components having the same first reference label irrespective of the second reference label.

FIG. 1A illustrates an exploded view of an embodiment of a security note according to embodiments of the invention.

FIG. 1B illustrates the security note of FIG. 1A in a delaminated state according to embodiments of the invention.

FIG. 1C illustrates a side view of the security note of FIG. 1A.

FIG. 2 is a flowchart depicting a process for manufacturing a security note according to embodiments of the invention.

### DETAILED DESCRIPTION OF THE INVENTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the present invention are directed to security notes that include secure information and/or precious metal laminates, as well as methods of making such security notes and/or laminates. Embodiments of the security notes include one or more advanced tamper-resistant security features that help protect the integrity of the secure information and, in some embodiments, may serve to verify the authenticity of the security note itself. In some embodiments, the security features may be tamper-evident, such that users know if a particular security note has been tampered with and may therefore render the note invalid. The security notes may be used as physical manifestations for electronic transactions, including serving as cryptocurrency notes, and/or may be used for protecting other secure information. While discussed largely in the context of financial instruments, it will be appreciated that the security notes and related methods of manufacture may be utilized in numerous other applications where there is a need for tamper-resistant data security techniques.

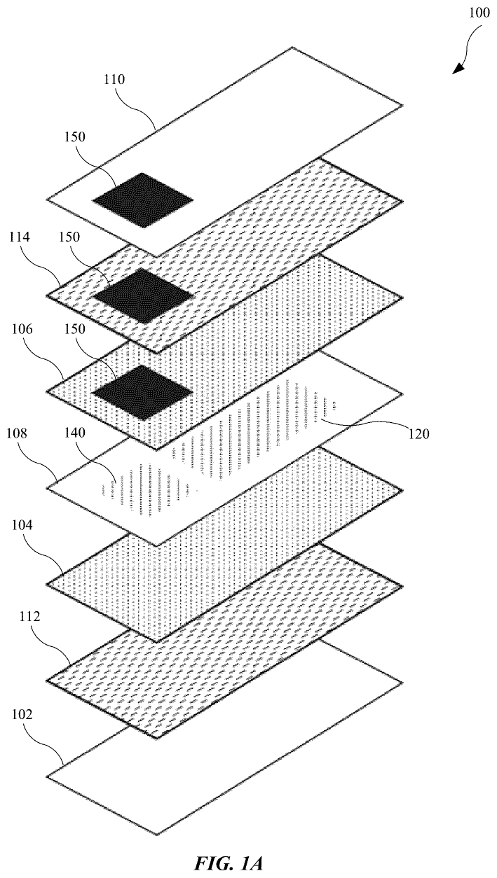

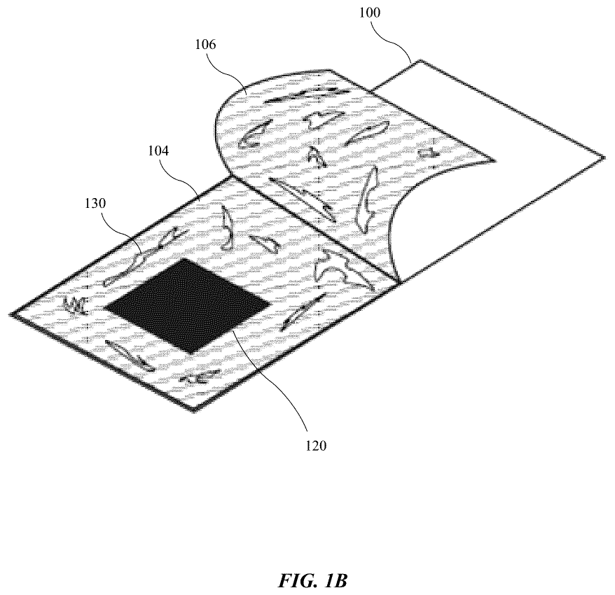

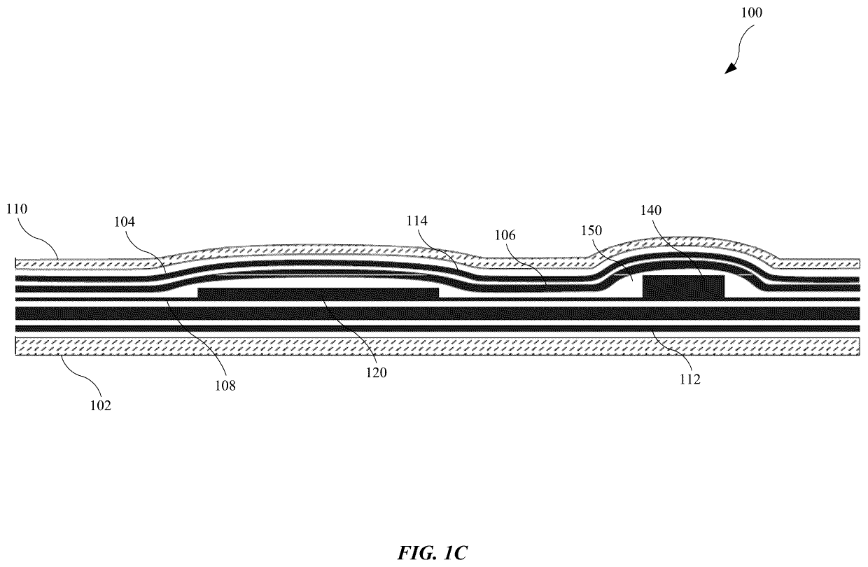

Turning now to FIG. 1, one example, of a security note 100 is illustrated. The security note 100 may include a number of layers that are coupled or otherwise secured together. For example, note 100 may include a first substrate 102. The substrate 102 may have a length, width, and a thickness. The length and width may define outer boundaries of the security note 100. The substrate 102 may be formed from polymeric and/or other transparent materials. For example, the substrate 102 may be formed from polyethylene terephthalate (PET), polyvinyl chloride (PVC), an acetate, a polycarbonate, a polyester, a polystyrene, a polypropylene, a polyethylene, polyvinylidene dichorlide (PVDC), other polymers, and/or combinations thereof. Oftentimes, the thickness of the substrate 102 may be between about 25 microns and 200 microns, although other thicknesses are possible in some embodiments. In some embodiments, rather than being fully transparent, the substrate 102 may be translucent. In some embodiments, a dye or other coloring agent may be applied to at least particularly color the substrate 102.

The note 100 may include two or more metallic (or otherwise opaque) layers. For example, note 100 may include a first base layer 104 that is positioned proximate the substrate 102 and a second base layer 106 that is positioned proximate the first base layer 104. Each base layer 104, 106 may be formed from various materials. For example, the base layers 104, 106 may be a crystalline layer. Crystalline layers may include metallic materials and/or ceramic materials in some embodiments. For example, the base layers 104, 106 may include ceramic materials such as, but not limited to, aluminum oxide, beryllium oxide, zirconium oxide, and/or other ceramic materials. The base layers 104, 106 may include metallic layers and may be formed from any type of precious and/or non-precious metal. For example, each base layer 104, 106 may be formed of gold, silver, platinum, palladium, rhodium, osmium, iridium, ruthenium, rhenium, indium, germanium, beryllium, tellurium, bismuth, aluminum, bronze, copper, nickel, cobalt, titanium, lanthanides, and/or other metals and/or alloys. In some embodiments, other opaque materials may be used in addition to, or in place of the base layers. Each base layer 104, 106 may be applied as a precisely measured quantity of one or more metals. For example, a quantity of metal deposited and/or otherwise applied may be measured by mass and/or thickness. In specific examples, the metal may be present in quantities of between about 25 mg to 2520 mg. In some embodiments, the metal may be applied at thicknesses of between about 96 nm and 8000 nm, and more commonly between about 200 nm and 6000 nm. In some embodiments, non-precious metal base layers may have thicknesses as low as about 96 nm, while precious metal layers may have layers as thin as about 200 nm. In some embodiments, the base layers 104, 106 may be the same, while in other embodiments, the base layers 104, 106 may have different compositions, thicknesses, other dimensions and/or other characteristics.

In some embodiments, the base layers 104, 106 may each be applied as a single planar or non-planar layer. However, oftentimes, one or both of the base layers 104, 106 may be applied as a number of sublayers, which may increase the precision of the application process, as well as enable more intricate designs of the precious metal. Any number of sublayers may be present within a given base layer 104, 106. In some embodiments, each of the sublayers may have a same thickness, while in other embodiments, one or more of the sublayers may have different thicknesses. For example, lower (first-applied) sublayers may be applied at greater thicknesses than upper (later-applied) sublayers. Such an arrangement may be particularly useful, as this may allow the later-applied sublayers to be thinner, more precisely controlled layers that may enable a total thickness of the sublayers to be carefully controlled to ensure that a substantially precise amount of metal is applied to the security note 100. It will be appreciated that thicker layers may be applied as upper layers in some embodiments. Additionally, some embodiments may have sublayers that are arranged in any order in relation to thickness of each sublayer. In some embodiments, a substantially precise amount of metal is within about 20% of a desired target amount (such as a thickness and/or mass), within about 15% of the desired target amount, within about 10% of the desired target amount, within about 7.5% of the desired target amount, within about 5% of the desired target amount, within about 4% of the desired target amount, within about 4% of the desired target amount, within about 3% of the desired target amount, within about 2% of the desired target amount, within about 1% of the desired target amount, within about 0.9% of the desired target amount, within about 0.8% of the desired target amount, within about 0.7% of the desired target amount, within about 0.6% of the desired target amount, within about 0.5% of the desired target amount, within about 0.4% of the desired target amount, within about 0.3% of the desired target amount, within about 0.2% of the desired target amount, within about 0.1% of the desired target amount, within about 0.05% of the desired target amount, or less.

In some embodiments in which a base layer 104, 106 is generally flat, the base layer 104, 106 may have a thickness that is uniform across a surface area of the base layer 104, 106 to within 15%, within 10%, within 5%, within 3%, within 2%, within 1%, within 0.5%, within 0.025%, within 0.01% or less.

In some embodiments, to enable the precise application of a base layer 104, 106, a number of sublayers may be applied and a total thickness of these sublayers may be measured prior to the application of one or more final sublayers. Based on the measured thickness, a thickness of the one or more final sublayers may be determined to achieve a desired total amount of the precious metal. The one or more final sublayers may then be applied to the prior-applied sublayers to create a base layer 104, 106 having a desired thickness and/or cross-sectional shape.

In some embodiments, the sublayers may be generally flat and/or uniform, however in other embodiments, one or more of the sublayers may have a non-flat shape and/or be otherwise non-uniform across a length and/or width of the sublayer. For example, sublayers may include one or more tapers, contours, and/or other transitions between thick and thin portions. In some embodiments, sublayers having different directions of taper may be arranged together, alternate, and/or provided in another arrangement. In some embodiments, the taper may be constant, while in other embodiments the taper may be curved and/or otherwise variable. Additionally, in some embodiments one or more of the sublayers may be flat and/or otherwise shaped. The arrangement of sublayers may create a generally flat base layer 104, 106, or may produce a base layer 104, 106 with one or more raised and/or lowered areas. The contours may include any number of concave and/or convex areas. In some embodiments, the various contours, tapers, etc., of the various sublayers may combine to form a generally flat or planar base layer 104, 106, while in other embodiments, one or both of the base layers 104, 106 may be non-planar. It will be appreciated that contours, such as convex and/or concave portions, may be symmetrical and/or may include asymmetrical portions. In some embodiments, a single sublayer may include one or more flat/planar portions, tapered portions, and/or concave/convex portions.

The various sublayers may be coextensive with one another, while in other embodiments, one or more of the sublayers may extend beyond the outer peripheries of one or more other sublayers. In some embodiments, one or more (possibly all) sublayers may define gaps within an interior of the given sublayer. This may create a portion of the base layer 104, 106 that is thinner than a remaining portion or that is entirely devoid of metal to create a transparent or translucent window. In some embodiments, if the thin portion is sufficiently thin, the thin portion may serve as an authentication feature. As just one example, if the metal is gold and the thin portion is less than about 200 nm in thickness, the gold may appear turquoise when light is shined through the thin portion. This particular optical transmission feature is unique to gold and may enable users to quickly discern whether the security note 100 actually contains gold, rather than some counterfeit material, as this is a very difficult property to replicate, even with the use of dyes. These thin portions may be of any shape and/or size. In some embodiments, these thin portions may be used to generate intricate designs. As just one example, thin areas in different sublayers (or a single sublayer) may be deposited to form an image. This image may have unique optical properties that serve as an authentication measure and/or provide a unique aesthetic quality. In one particular embodiment, the thin portions may define a clover design, with each of the leaves being translucent. As noted above, if the translucent portions are gold, the leaves may look turquoise as lighted is shined through the clover. In some embodiments, a thickness of one or more of the leaves may be different, which may provide unique light transmission properties through the different leaves.

In some embodiments, the sublayers may have different shaped profiles along different axes of the security note 100. For example, along a length of the security note 100, one or more of the sublayers may have a tapered profile, while along a length of the security note 100, one or more of the sublayers may have a concave/convex profile. In some embodiments, a single sublayer may have two different profile shapes along different axes, such that when viewed from the side the sublayer may have a first shape and when viewed from an end the sublayer may have a second shape. Embodiments may therefore have sublayers that have very complex deposition (or other application) patterns. In some embodiments, boundary lines of the various sublayers may be visible to the naked eye, while in other embodiments the sublayer boundaries may be invisible without the aid of magnifying implements. In some embodiments, a marker material may be used to distinguish between the different sublayers.

Each base layer 104, 106 may include a textures and/or surface finish. The surface finish and/or texture of the first base layer 104 may be the same or different than a surface finish and/or texture of the second base layer 106. For example, each base layer 104, 106 may have a polished finish to increase the shine and/or reflective properties of the precious metal. Various finishes may include antique finishes, brushed finishes, hammered finishes, satin finishes, and/or oil-rubbed finishes. Various textured may include grooves, diffraction gratings, and the like. Additionally, various textures may be applied to the base layer 104, 106. In some embodiments, an entire outer/exposed surface of the base layer 104, 106 may have a single surface finish/texture, while in other embodiments one or more portions of the exposed surface of the base layer 104, 106 may have different finishes/textures. For example, a first major surface (such as the bottom surface) of the base layer 104 may have a first finish/texture while a second opposite major surface (such as the top surface of the second base layer 106) may have a second, different finish/texture. Additionally, in some embodiments, multiple portions of the base layer 104, 106 on a single major surface may have different surface textures/finishes. This may be particular useful in embodiments in which a portion of the base layer 104, 106 is used to define a shape, text, and/or other image for security, aesthetic, and/or other purposes. For example, a main portion of the surface of the base layer 104, 106 may have a first surface finish/texture, while a smaller portion of the surface having a desired shape, text, and/or other image may have a different surface finish/texture. This may enable the smaller portion to be easily distinguished from the main portion.

In some embodiments, the base layer 104, 106 may include feathering, such as near the edges of one or more of the sublayers. The feathering may be a lateral reduction of the thickness of the base layer 104, 106 and/or one or more of the sublayers. This may be used to create precisely thinned regions, which may provide unique optical characteristics, such as those described above. The use of feathering may create a security note 100 that is particularly difficult to counterfeit. In some embodiments, the feathering may have an optical density ranging from 1 to 4. In some embodiments, a dielectric material may be printed on or otherwise deposited on a portion of the base layer 104, 106. The dielectric material may have a thickness that is between 0.25 to 1.5 of a quarter wave thickness. The thickness may be selected to produce various colors when light is reflected off of the dielectric material.

The security note 100 may include security information 120, such as one or more codes, serial numbers, account numbers, personal information items, informational features, encryption keys, pin numbers, authentication information/images, and/or other sensitive information. The security information 120 may be provided on the security note 100 in such a manner that that the security information 120 is not visible from outside the security note 100. For example, the security information 120 may be embedded within and/or between the base layers 104, 106 such that the security information 120 is hidden and protected by the base layers 104, 106 (and/or other metallic/opaque layers of the security note 100) and/or by a number of security features of the security note 100. The hidden security information 120 may then only be accessed by delaminating the security note 100, as will be discussed in greater detail below. Oftentimes, the security information 120 may be printed and/or otherwise provided between at least two opaque layers of the security note 100. For example, the security information 120 may be printed on inner-facing surfaces of one or both of the base layers 104, 106 (or other opaque layers of the security note 100). In some embodiments, alternatively or in addition to providing security information 120 on inner-facing surfaces of one or both of the base layers 104, 106, a separate security layer 108 may be provided between the base layers 104, 106. Security information 120 may be printed on, formed in and/or on, or otherwise provided on and/or in the security layer 108. The security information 120 may be formed applying ink, other pigments, release material and/or adhesive material to one or more of the layers of the security note 100, by adding and/or removing material from one or more layers of the security note 100 (such as the material forming the respective layer), by magnetic ink or pigment, by electrically charged material, by chemically altered material, and/or using other techniques. The security information 120 may be provided in human readable and/or computer-readable forms (such as barcodes, QR codes, etc.). In some embodiments, some or all of the security information 120 may be encoded in a digital form. For example, the security information 120 may be encoded on a radio frequency (RF) chip that may be affixed and/or otherwise provided on the base layers 104, 106 and/or a security layer 108. In some such embodiments, the security note 100 may include one or more RF blocking layers (which may be formed by the base layers 104, 106 and/or other layers of the security note 100 and/or be formed as separate layers) that may prevent interrogation of the RF chip until the security note 100 is delaminated to provide unimpeded access to the RF chip.

The security layer 108 may be formed of any material and include opaque, translucent, and/or transparent portions. For example, the security layer 108 may be formed of natural materials (such as paper, natural fibers, wood, and/or composites thereof), synthetic materials (polymers, synthetic fabrics, glass, ceramic, etc.), metals (precious or non-precious), and/or combinations thereof. While shown with a single security layer 108, it will be appreciated that any number of security layers (which may be identical or different) may be utilized and that some embodiments may omit a security layer entirely. As will be discussed in greater detail below, the security note 100 may include other security features, which may be provided on any layer of the security note 100 including the security layer 108 and/or a separate layer.

In some embodiments, the security note 100 may include a second substrate 110 that covers the second base layer 106. Substrate 110 may help protect the second base layer 106 from damage associated with handling, misuse, and/or exposure to the environment. This may be particular useful when metals such as copper, brass, nickel, silver, etc., are used, which may be subject to oxidization. The substrate 110 may be identical to or similar to the substrate 102. In other embodiments, the substrate 110 may be quite different from the substrate 102. In some embodiments, the substrate 110 may be formed of a same or similar material as substrate 102. For example, the substrate 110 may include polyethylene terephthalate (PET), polyvinyl chloride (PVC), an acetate, a polycarbonate, a polyester, a polystyrene, a polypropylene, a polyethylene, polyvinylidene dichorlide (PVDC), other polymers, and/or combinations thereof. Oftentimes, the substrate 110 may have a thickness of between about 25 microns and 200 microns.

In some embodiments, the security note 100 may include only two metallic (and/or otherwise opaque) layers. In some such embodiments, the first substrate 102 and/or second substrate 110 may be applied directly to one of the base layers 104, 106, such as by using an adhesive. In some embodiments, additional base layers may optionally be included. For example, in some embodiments, an intermediate base layer 112 may be positioned between the first base layer 104 and the substrate 102 and/or an intermediate base layer 114 may be positioned between the second base layer 106 and the second substrate 110. The intermediate layers 112, 114 may be coupled with a respective one of the substrates 102, 110. In some embodiments, this may involve the use of an adhesive that is applied between the respective substrate 102, 110 and intermediate layer 112, 114.

In some embodiments, the intermediate layers 112, 114 may be identical to one another, while in other embodiments, the intermediate layers 112, 114 may be different. For example, the material, thickness, pattern, surface finish, texture, and/or characteristic of the intermediate layers 112, 114 may be different from one another. In some embodiments, one or both of the intermediate layers 112, 114 may be identical to one or both of the base layers 104, 106, while in other embodiments, one or both of the intermediate layers 112, 114 may have different materials, thicknesses, patterns, surface finishes, textures, and/or characteristics than one or both of the base layers 104, 106. In some embodiments, one or both of the intermediate layers 112, 114 may include one or more security features and/or security information, such as that described above.

As disclosed above, in some embodiments, the substrates 102, 110 may each be applied directly to one of the base layers 104, 106 and/or intermediate base layers 112, 114. However, in other embodiments, an additional transition layer may be formed between the respective base layer and the substrate 102, 110. This may be particularly useful in embodiments in which the base layer being secured to the substrate 102, 110 includes certain precious metals (such as, but not limited to, gold), which may present bonding challenges. In such embodiments, a transition layer may be deposited and/or otherwise applied to the processed inner surface of the respective substrate 102, 110. The transition layer may provide several benefits. For example, the transition layer may enable a thinner substrate 102, 110 to be utilized, while still providing stability to the security note 100. The use of a transition layer may also help balance heat load during deposition processes, and may help achieve greater performance. In particular, the transition layer may help increase the adhesion of precious metals to the substrate 102, 110. The transition layer may be transparent in order to enable the aesthetic properties of the base layers to remain visible from an outside of the security note 100, as well as to enable a window 150 to be transparent and/or translucent. In some embodiments, the transition layer may include one or more transition metals. Oftentimes, the transition metals may include oxides and/or carbides. For example, the transition layer may include nickel alloys, titanium, vanadium, chromium, zirconium, niobium, molybdenum, hafnium, tantalum, tungsten, nickel chromium alloys, titanium carbide, titanium oxide, and/or titanium zirconium. Oftentimes, the transition layer may have a thickness of between about 0.5 nm and 10 nm.

In some embodiments, some or all of an inward-facing surface of one or both substrates 102, 110 may be processed and/or otherwise prepared prior to being coupled with inner layers of the security note 100. For example, a portion of the inner surface may be removed using a pretreat such as, but not limited to, plasma, sodium hydroxide, sputtering, etc. Hydrogen atoms may be blown off and/or oligomers may be removed. This processed surface may create better adhesion between the substrate 102, 110 and the adjacent inner layers, especially when the adjacent layers include a precious metal.

As indicated above, at least some of the security information 120 may be hidden and protected by opaque layers of the security note 100, such as the base layers 104, 106. Therefore, to access this hidden security information 120, a user must delaminate at least a portion of the security note 100. In particular, the user must separate the opaque layer that is most proximate the obscured security information 120 from the layer on which the security information 120 is provided in order to gain visual access to the security information 120. Delamination may be performed in various manners, the most common of which is to peel or otherwise mechanically separate the respective layers. However, in some embodiments, alternatively or in addition to peeling, the security note 100 may be delaminated using a mask to break adhesion, by applying heat to the security note 100, splitting the security note, and/or using a chemical solvent. In some embodiments, all of the security information 120 and/or other hidden information may be hidden between a single pair of layers of the security note 100 such that a single delamination step is required to access all of the hidden information. In other embodiments, the security information 120 and/or other hidden information may be hidden between multiple pairs of layers such that multiple delamination steps are necessary to access all of the hidden information.

To prevent a user from delaminating the security note 100 to access the security information 120 and then re-laminating or otherwise reassembling the security note 100, the security note may include one or more tamper-resistant and/or tamper-evident features that may alert users that the integrity of the security note 100 has been compromised. For example, color changing materials (such as those that easily oxidize) may be provided on or proximate the layer on which the security information 120 is provided such that any delamination to access the security information 120 will result in irreversible damage 130 that manifests as readily identifiable color changes to the area around the security information 120 that indicate previous tampering has occurred. The color change materials may include inks, adhesives, dyes, quickly oxidizing (or otherwise corroding) metals (such as certain purities and/or alloys of silver), color change threads, and/or other substances. Some of the materials forming the layer on which the security information 120 is provided and/or adjacent layers may be designed to break, metal may be turned into flakes and/or powder in a random or selected pattern, a material may be partially removed, atomize, and/or otherwise become irreversibly damaged upon delamination. For example, the one or more of the metallic and/or intermediate layers may atomize and/or otherwise break (oftentimes with some of the metal remaining adhered to a separate layer (such as one of the substrates 102, 110, and/or other transparent/translucent layer) while a majority of the metal is separated during delamination) and/or otherwise be removed, which leaves very visible instances of irreversible damage 130 as shown in FIG. 1B. In some embodiments, the irreversible damage 130 may include folds and/or creases being permanent formed within the security note 100, breaking of one or print layers (which may include the security information 120 and/or include other information, such as identification information as described elsewhere herein), breaking of security threads (such as color-shift threads), separation of one or more print layers onto distinct surfaces of the security note 100, and/or and de-metallization of holograms (when included). Oftentimes, this irreversible damage 130 may be visible from an outside of the security note 100. This allows a user to view damage to the security note 100 and determine that the security note 100 has been previously delaminated and/or otherwise tampered with. In some embodiments, the irreversible damage 130 may include tearing of one of more of the layers of the security note 100. In some embodiments, tamper evident/resistant material, such as that described above, may be positioned about a periphery of the security information 120 such that to access the security information, the tamper-evident/resistant material must be broken.

Oftentimes, the irreversible damage 130 may be randomly oriented on the security note 100 and may be generated by the particular position, force, and/or type of delamination used. In other embodiments, the construction of the security note 100 may cause intentional irreversible damage at one or more locations (possibly in addition to random damage). For example, some areas of the security note 100 may include stronger and/or otherwise different adhesives, some layers (such as the base layers 104, 106) and/or portions thereof may be applied using different techniques with different adhesion/bonding characteristics, some areas may utilize weaker materials that are positioned in designated areas, some layers may include pre-perforated sections that are designed to tear or otherwise become irreversibly damaged upon delamination, and/or other forms of location-specific irreversible damage mechanisms may be utilized.

In addition to the tamper resistant/evident features described above, the security note 100 may include may include one or more text-based and/or image-based markings 140 that may serve as identifying marks and/or security features that may provide anti-counterfeiting and/or authentication means. In some embodiments, the markings 140 may include one or more micro patterns, embossed areas, relief structures, holograms, laser-etched elements, lithographs, and/or diffraction gratings. In some embodiments, the markings 140 may provide identification of one or more pieces of information, such as a source of the security note 100, a type of precious metal (if present) in the security note 100, a purity of precious metal (if present) in the security note 100, an amount of precious metal (if present) in the security note 100, a value of the security note 100, a serial number of the security note 100, and/or other information.

In some embodiments, the markings 140 may include various security features including small/trace quantities of a metal (oftentimes different than the metal in the base layers 104, 106), embedded fibers, a dye coating (which may be fluorescent in some embodiments), a spectral-shifting coating or other treatment, particles (such as nanoparticles) having relatively unique spectral properties.

In some embodiments, the markings 140 may include a number of apertures formed through the security note 100, one or more blind holes formed through a portion of the thickness of the security note 100, one or more micro-damage elements (such as a contaminant distribution arrangements, depressions, and/or bas-relief surfaces). In some embodiments, all of the markings 140 and/or other security features may be provided on a single layer of the security note 100, such as one of the base layers 104, 106, the security layer 108, one of the intermediate layers 112, 114, and/or one of the substrate layers 102, 110. In other embodiments, the markings 140 and/or other security features may be provided on multiple layers. In some embodiments, one or more of the markings 140 and/or other security features may be provided as a separate layer of material within the security note 100. Some or all of the markings 140 may be visible at all times (such as by providing the marking 140 on an outer surface of the outermost opaque layer on a given side of the security note 100 and/or by providing in on or in an outer transparent/translucent layer). In other embodiments, some or all of the markings 140 may be hidden by one or more opaque layers and thus be accessible only upon delaminating the security note 100.

As indicated above, in some embodiments the markings 140 may include one or more holograms. In some embodiments, the holograph may be formed as part of and/or otherwise integrated directly inter one or more of the layers of the security note 100. For example, the hologram may be formed as part of or formed onto one or more of the base layers 104, 106, intermediate layers 112, 114, security layer 108, and/or substrates 102, 110. In some such embodiments, the metallization of the hologram may be done using a base layer on which the hologram is formed. In other embodiments, a holographic sticker may be affixed to one of the interior layers of the security note 100, which may protect the hologram from tampering without delaminating the security note 100.

In some embodiments, the markings may include one or more relief structures. For example, a relief structure may be formed from depositing onto and/or removing material from one of the layers of the security note 100. The relief structure may include one or more cavities or protrusions that define a random and/or patterned 3-dimensional structure within or on the security note 100. The relief structure may be formed on an outer layer of the security note 100 to provide the security note with a 3-dimensional texture in some embodiments. In some embodiments, the relief structure may be formed on and/or coupled with an interior layer of the security note 100. In some such embodiments, the outer layers (such as adhesives and/or substrates) may be applied in a manner (such as with uniform thickness) such that the outer layers have a contour matching the relief structure and therefore imparting the 3-dimensional texture on an outer surface of the security note such as shown in FIG. 1C. In some embodiments, the outer layers may be applied with variable thickness such that one or more of the outer layers fill the voids in the relief structure while still providing a generally planar outer surface.

In some embodiments, adhesive layers may be provided between one or more adjacent layers of the security note 100. For example, an adhesive layer may be disposed between the first base layer 104 and the second base layer 106 to secure the two layers together. As another example, adhesive layers may be applied on either side of the security layer 108 to help bond the security layer 108 to the base layers 104, 106. It will be appreciated that in some embodiments none of the layers of the security note 100 are adhesively bonded, while in other embodiments all layers are adhesively bonded. Adhesive layers may be positioned between any two adjacent layers. The adhesive layers may be transparent, translucent, and/or opaque. In some embodiments, the adhesive layer may include an acid-resistant, heat resistant, and/or solvent-resistant binder, which may hinder the ability to tamper with the security note 100 to access secure data provided within the area of the note 100 between the first base layer 104 and the second base layer 106 (such as on inner surfaces of one or both of the base layers 104, 106 and/or on one or more intervening layers, such as security layer 108). In some embodiments, the adhesive layer may serve as a tamper-evident security feature. For example, the adhesive layer may include an adhesive or other substance that changes color due to oxidation and/or trauma. For example, an adhesive that begins to oxidize when exposed to air may alert users if the first base layer 104 and second base layer 106 have been separated, as any portion of the adhesive layer that has been exposed due to the separation will be partially or fully oxidized, and thus a different color than the adhesive layer for an untampered-with note 100.

In some embodiments, the security note 100 may define one or more transparent and/or translucent windows 150 that enable a user to see through all or part of the security note. For example, the window 150 may enable a user to optically view various layers of the security note 100 other than the outermost metallic (or otherwise opaque) layers. Each window 150 may be positioned at any location within the boundaries of the security note 100. In some embodiments, the window 150 may be centered within an interior of the security note 100. In some embodiments, the window 150 may share one or more peripheral edges with the rest of the security note 100. For example, the window 150 may form a border about all or a portion of the security note 100. In some such embodiments, a border window 150 may reduce the amount of adhesion needed to form the security note 100, as there may be less material (such as metals) deposited on or between the substrates 102, 110. In some embodiments, the window 150 may extend along two adjacent edges of the security note 100 and/or contact two or more opposing/non-adjacent edges of the security note 100. In some embodiments, all of the window 150 may be positioned inwardly of the peripheral edges of the security note 100 such that the window 150 is framed by the various layers of the security note 100, including the base layers 104, 106. Each window 150 may have any shape and/or size. In embodiments with multiple windows 150, each window 150 may be the same size and/or shape, or may be different. The windows 150 may be positioned symmetrically and/or asymmetrically about the security note 100.

In some embodiments, the window 150 may extend through an entire thickness of the security note 100, such that a hole is defined through an entire thickness of the security note 100. The window 150 may be defined in one or more opaque layers (such as base layers 104, 106 and/or intermediate layers 112, 114), such as to expose a surface of one of the base layers 104, 106 through one or both of the intermediate layers 112, 114 and/or to expose the security layer 108. The window 150 may extend through one or both of the substrates 102, 110. It will be appreciated that window 150 may be defined through any combination of one or more layers of the security note 100.

In some embodiments, one or more of the markings 140 and/or some of the security information 120 may be in alignment with the window 150 to enable such information to be visible from an outside of the security note 100 via the window 150 without the need to delaminate the security note 100. As just one example, a public encryption key is provided as marking 140 on one or more inner layers of the security note 100 and visible via the window 150, while a corresponding private encryption key is hidden as protected security information 120 between two or more opaque layers. In some embodiments, the window 150 may extend to show layers in which tamper resistant/evident markings are provided. This may enable users to view any signs of tampering (such as due to prior delamination of the security note 100) through the window 150. For example, color-changes of materials, de-metallization features, flaking, creasing, and/or other forms of irreversible damage 130 may be visible from the outside of the security note 100 via the window 150. Markings 140 serving as security features may be visible via one or more windows 150. For example, markings 140 having inks or other materials with unique optical transmission properties may be provided in various layers and aligned within the window 150 for viewing prior to delamination of the security note 100. These unique optical transmission properties may be difficult to counterfeit, which may further enhance the security of the note 100. In one particular example, one of the base layers 104, 106 (and/or other layer) may contain a thin portion of gold in alignment with the window 150. For example, the thin portion may be less than about 200 nm in thickness, which may cause the gold to appear turquoise when light is shined through the thin portion/window 150 and may serve as verification that the security note 100 is authentic/actually contains gold. In some embodiments, the markings 140 may include feathered metal portions that provide unique optical characteristics.

In some embodiments, the markings 140 visible through the window 150 may include relief structures and/or holograms as described above. The window 150 may help focus a user's eye on the markings 140 visible therein, which may allow for quick identification of security features and may enable various optical characteristics of the hologram to be more easily recognized by the eye. Additionally, the window 150 may help optimize the metallic thickness of hologram and/or relief structure, as the window 150 may enable a portion of the hologram and/or relief structure to protrude through one or more additional layers of material. In some embodiments in which a substrate 102, 110 and/or adhesive layers (or other transparent/translucent) layer extends over or otherwise covers the window 150, the transparent/translucent material of the respective cover layer may extend over the window 150 without penetrating the opening/depth of the window 150, leaving an air gap within the security note 100. In other embodiments, the transparent/translucent material may flow into the window 150 to fill in the void of the window 150. In such embodiments, the outer surface of the outermost layer may be planar and/or may follow a contour formed by a shape of the window 150.

In some embodiments, multiple base layers may each include a window 150 that is at least partially offset from windows 150 in other layers. For example, windows 150 may be formed in a clover design with four leaves, each formed by a different window 150 in a different layer of the security note 100. In such embodiments, the leaves may each be translucent, with a slightly different appearance based on a depth of the layer having the window 150 that defines the respective leaf. In one particular example, each layer may be gold having a thickness of between about 50 nm and 200 nm, such that a total thickness of the base layers is between about 200 nm and 800 nm. Separate leaf-shaped windows 150 may be formed through three of the layers such that each leaf contains only one thin layer of gold. Light may pass through each leaf, making the leaf appear turquoise, while the rest of the security note 100 appears opaque and gold. In some embodiments, a similar window arrangement may be used with four base layers of different metals. In such an embodiment, each leaf may appear to be a different color/metal. While described in relation to clover shapes, it will be appreciated that embodiments are not so limited and that various shapes formed with offset windows 150 may be formed in accordance with the present invention.

In some embodiments, windows 150 may be formed in each major surface (i.e., top and bottom) of the security note 100 and offset from one another, which may enable a middle section of the security note 100 (such as the base layers 104, 106, the area between the base layers 104, 106, and/or security layer 108) to be visible from either side of the security note 100. In some embodiments, markings 140 (which may be identical or different) may be visible through both windows 150, enabling at least one marking 140 to be viewed from either major surface.

In a particular example shown in FIG. 1, the security note 100 may have seven layers. For example, outer substrates 102 and 110 may be formed from a polymer, such as PET. A security layer 108 may be positioned between base layers 104, 106, which may be formed of copper. The security layer 108 may include security information 120 positioned within a first portion of the security layer 108 (on one or both surfaces) and markings 140 (which may include security features, identification information, and/or security information) on a second portion of the security layer 108. Intermediate base layers 112, 114 may be positioned on outer surfaces of the first base layer 104 and second base layer 106, respectively. The intermediate base layers 112, 114 may be formed from a different material than the base layers 104, 106, such as aluminum. One or more of the layers may be coupled together using an adhesive. For example, the security layer 108 may be coupled with base layers 104, 106 using an adhesive.

A window 150 may be defined in one or more of the layers to provide visual access to the markings 140, while the security information 120 is obscured on both sides by the opaque layers. For example, as illustrated the window 150 is defined in the substrate 110, intermediate layer 114, and base layer 106, which enables the markings 140 to be visible from one side of the security note 100. To access the security information 120, the security note 100 must be delaminated. As described above, this is typically done by peeling or otherwise separating at least one of the layers from the rest of the security note 100. For example, in the present embodiment, the base layer 106 must be delaminated from the security layer 108 such that the security information 120 is no longer obscured by the base layer 106 (and intermediate layer 114). This delamination may cause irreversible damage 130 to one or more layers of the security note 100 as described above.

It will be appreciated that the embodiment described above is merely representative of one of any numerous permutations of layers and designs of security note 100 in accordance with the present invention and that variations exist. It will be further appreciated that any number of layers and/or combination of layers may be used in particular embodiments. In a simplest form, a two-layer security note may be provided, with security information being printed on inner surfaces of one or both of the layers such that the two layers must be delaminated to reveal the security information while irreversibly damaging the security note and/or causing one or more tamper-evident features to be activated. Other transparent, translucent, and/or opaque layers may be added to increase complexity, security, durability, aesthetics, and/or to otherwise enhance the security note may be used in various embodiments. For example, in one embodiment, at least one decoy layer may be provided, which may contain patterns that do not exhibit security information. It will be further appreciated that while shown as having a symmetrical layout of layers, embodiments are not so limited. For example, a security note may have a single opaque layer on a first side of the security information and multiple opaque layers on a second side of the security information.

In some embodiments, the security notes 100 described herein may be rectangular or generally rectangular in shape, however the security note 100 may be any shape in various embodiments. In some embodiments, peripheral edges of one or both of the substrates may define the outer boundaries of the security note 100, while in other embodiments one or more of the other layers may define the boundaries of the security note 100. In some embodiments, all of the layers of the security note 100 may be coextensive with one another (with the exception of any windows 150 present), while in other embodiments, one or more layers may be inward of and/or extend beyond the peripheral edges of one or more of the other layers in one or more directions. In a particular embodiment, peripheral edges of one or both of the substrates may extend beyond peripheral edges of the inner layers of the security note 100, which may fully protect the internal layers, as well as create a transparent border (window 150) about the inner layers.

In some embodiments, the markings may include various security features including small/trace quantities of a metal (different than the metal in the base layer), embedded fibers, a dye coating (which may be fluorescent in some embodiments), a spectral-shifting coating or other treatment, particles (such as nanoparticles) having relatively unique spectral properties.

In some embodiments, the security note 100 may include one or more textured outer surfaces. For example, one or both of the substrate layers may be applied and/or formed to include a textured surface, such as a grooved, bumpy, embossed features and/or other textured surface. In some embodiments, the base layers may be applied to form the texture of the security note 100 such that when one or both of the substrates are affixed with the base layers, the texture of the base layer is imparted on the respective substrate.

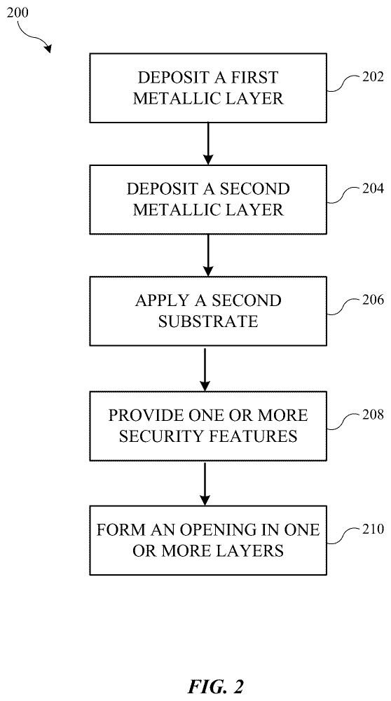

FIG. 2 illustrates one embodiment of a process 200 for manufacturing a security note. Process 200 may be used to form security notes such as security note 100 described herein. Process 200 may begin at operation 202 by depositing a first base layer on a first transparent substrate. The first base layer may include at least one precious and/or non-precious metal. In some embodiments, the base layer may be applied using sputter deposition, such as ion-beam sputtering, reactive sputtering, ion-assisted deposition, high-target-utilization sputtering, high-power impulse magnetron sputtering, and/or gas flow sputtering. In some embodiments, the base layer may be applied via electroplating, colloidal deposition (and subsequent removal of a colloidal suspension liquid via application of heat and/or vacuum and/or densification by heat and/or pressure), adhesive lamination of metallic leaf, physical-vapor deposition, atomic layering, vacuum deposition, and/or other deposition process.

In some embodiments, depositing the base layer may include applying a number of sublayers of the precious metal atop the transparent transition layer. For example, the metal may be applied using a number of deposition steps that may enable greater control and precision of the amount and pattern of metal provided within the laminate. In some embodiments, the sublayers may all be applied using a single type of deposition process, while in other embodiments, multiple types of deposition processes may be used to deposit the sublayers. For example, the first sublayers may be deposited using a first method, while the final sublayers are deposited using a second method, which, in some embodiments, may be a more precise deposition method than the first. As just one example, the first sublayers may be deposited using evaporative deposition, while the final sublayers are deposited using sputtering. In some embodiments, each of the sublayers may have a same shape and/or thickness, while in other embodiments one or more of the sublayers may have different shapes and/or thicknesses. For example, in some embodiments, earlier-applied sublayers (closer to the substrate and/or transition layer) may be thicker than one of more of the last-applied sublayers. This may be particularly advantageous as it allows a bulk of the precious metal to be deposited rather quickly, with the last portion of the precious metal to be carefully deposited to provide a precious amount of total precious metal within the laminate. Additionally, the use of thinner sublayer passes when depositing thicker base layers, as depositing thicker sublayers may cause melting and/or over-depositing. As just one example, the process 200 may include, prior to depositing the last sublayer (or multiple last sublayers), measuring a total thickness of previous sublayers to determine a thickness of the last sublayer (or number of last sublayers). For example, the final sublayer thickness may be based on a difference between the measured thickness of the previous sublayers and a desired total thickness of the base layer. The last sublayer (or multiple last sublayers) may then be deposited at the desired thickness. In some embodiments, rather than measuring the previous sublayers, the deposition process may be predefined to deposit a number of sublayers of a desired thickness (constant and/or variable) and/or shape to achieve a base layer of a desired shape and/or thickness. The shape and/or thickness of each of the sublayers may be the same or different. In some embodiments, one of more of the sublayers may be non-planar. In such embodiments, the last sublayer may be applied with variable thickness to produce a generally planar base layer. In other embodiments, the last sublayer may be applied with a flat and/or variable thickness to produce a non-planar base layer. In some embodiments, to adjust the thickness and/or profile shape of a sublayer, a speed of a cathode (or other deposition tool) and/or power supplied to the deposition tool may be altered.

In some embodiments, the sublayers may have a tapered and/or curved profile across a width and/or length of the sublayers as described herein. For example, one or more of the sublayers may have a first profile in a machine direction and a second profile in a cross-machine direction. As just one example, one or more of the sublayers may have a tapered profile in the machine direction, while one or more of the sublayers may have a concave and/or convex profile in the cross-machine direction. It will be appreciated that any shape and/or combination of shapes of profiles may be provided in one or more sublayer of the base layer. Each outer surface of the base layer may have a same or different surface finish and/or texture which may be applied before and/or after the base layer is applied to the substrate. In some embodiments, one or more intervening layers are applied between the first base layer and the first substrate. For example, a transition layer containing a transition metal, such as an oxide and/or carbide, may be deposited and/or otherwise applied to the substrate prior to applying the first base layer. For example, the transition layer may be sputtered, deposited via evaporation, ion plated, chemical vapor deposited, and/or otherwise applied to the substrate. This may be particularly useful when the first base layer includes a precious metal, such as gold, which may be more difficult to adhere to the substrate. The substrate may oftentimes be formed of a transparent or translucent polymer. In some embodiments, prior to applying the transition layer to the substrate, the substrate may be processed and/or otherwise prepared to increase the adhesion between the substrate and subsequently-applied layers.

For example, the processing steps may include removing a portion of the first transparent substrate, removing hydrogen atoms from the first transparent substrate via dehydrogenation, cleaning the first transparent substrate, and/or removing oligomers from the first transparent substrate. In some embodiments, the substrate may be corona treated to increase adhesion. In some embodiments, alternatively, or in addition to the transition layer, one or more intermediate base layers may be deposited on the substrate prior to depositing the first base layer. The intermediate layers may be the same or different than the first base layer and may be applied using the same or different techniques.

In some embodiments, the process 200 may also include feathering a portion of the base layer. This feathering may create thinner areas within the base layer and/or otherwise create areas with unique optical properties, which may be used as security features that can be used to verify the authenticity of the laminate. The feathered areas may have an optical density of between about 1 and 4 and may be translucent and/or reflective. In some embodiments, the feathering may be done by first spraying and/or otherwise applying a substance (such as oil and/or ink) on a portion of the substrate. In some embodiments, the substance may be selected to evaporate in vacuum. As the base layer is deposited on the substrate, feathered shadows may be created at locations of the substance. In some embodiments, feathering may be applied by placing a heat-resistant object between a sputtering target and the substrate and then sputtering the base layer onto the substrate, which may cause feathering in the form of a shadow. In some embodiments, the heat-resistant object may be moved in a predetermined and/or random pattern, which may cause the shadowing/feathering to vary based on the movement of the heat-resistant object. In some embodiments, the moving object may move at a constant rate, which may result in a shadow of generally uniform appearance/thickness. In other embodiments, the moving object may move at a variable rate and/or pause at one or more locations, which may result in a shadow of variable thickness and/or otherwise non-uniform shadow. In some embodiments, the feathering may be created by mechanically scratching, chemically etching, and/or laser etching a portion of the base layer and/or one or more sublayers.

In some embodiments, the deposition process may create a feathered and/or otherwise thinned portion without the use of other substances. For example, the deposition process may involve depositing a thinner portion of precious metal on one or more areas (which may extend through one or more sublayers), creating a gap in one or more sublayers, and/or otherwise depositing the precious metal in a manner in which a thinned or feathered portion if provided. In some embodiments, the feathered area may be a random shape or pattern, while in other embodiments, the feathered area may be a predefined shape and/or textual message, such as a clover such as described above. In some embodiments, the feathered portion may be in only one sublayer and/or a subset of sublayers of the base layer. In some embodiments, in which the feathered portion is formed in only some of the sublayers, masking steps using inks, oils, heat-resistant objects, etc., may be performed by placing such materials on the substrate and/or on one of more previously applied sublayers. For example, the masking steps may include applying a masking agent (such as a layer of oil, ink, and/or other heat resistant material that may or may not be printable) atop areas in which no removal of material is desired. Portions of the sublayers and/or substrate that remain exposed (e.g., are uncovered by the masking agent) may be etched and/or otherwise removed, while the masked regions remain unchanged. The masking agent may be later removed through evaporation, by peeling, and/or other technique to expose the underlying substrate and/or sublayers. In some embodiments, a thickness of the feathered portion may be less than about 200 nm, while a thickness of the remaining portion of the base layer is greater than about 200 nm. In some embodiments, a thickness of the feathered portion may vary across an area of the security note so as to create a gradient of metal, which may be translucent across all or a portion of the gradient to provide variable optical properties across the gradient.

At block 204, a second base layer may be deposited on the first base layer (directly or with one or more intervening layers). In some embodiments, the second base layer may be formed from the same metal and/or a different metal than the initial base layer. The second base layer may include one or more precious and/or non-precious metals. In some embodiments, an outer surface (facing away from the first base layer) of the second base layer may have a same or different surface finish and/or texture as an outer surface of the first base layer. At block 206, a second transparent substrate may be applied to the second base layer. The second substrate may be identical to the first substrate in some embodiments, while in other embodiments, the second substrate may be formed from a different material, a different color, a different thickness, and/or have other distinct properties. In a particular embodiment, the second substrate may be formed from a protective lacquer that is applied over the inner layers of the security note. In some embodiments, the second transparent substrate may be applied directly to the base layer. In other embodiments, a second transition layer and/or one or more intermediate metallic (or otherwise opaque) layers may be disposed between the second base layer and the second substrate. In some embodiments, prior to applying the second substrate, the second substrate may be processed and/or otherwise prepared to increase the adhesion between the second substrate and the previously-applied layers. For example, the processing steps may include removing a portion of the second substrate, removing hydrogen atoms from the second substrate via dehydrogenation, cleaning the second substrate, and/or burning off ligamers from the second substrate. In some embodiments, the second substrate may be applied to the second transition layer, intermediate base layer, and/or the base layer using adhesive lamination. In embodiments in which the base layer is textured, feathered, and/or otherwise has a variable thickness, the second substrate may be applied with a constant thickness, which may result in the texture and/or other contour being passed through to the second substrate (and subsequently, the laminate). In other embodiments, the second substrate may be applied with a variable thickness so as to fill in voids formed by the texture and/or profile of the base layer and impart a planar outer surface to the second substrate and laminate.

At block 208, one or more security features may be provided between the first base layer and the second base layer. For example, the security features may be formed on and/or otherwise provided on inner surfaces of one or both base layers and/or be provided as separate layers, such as a security layer. In some embodiments, no adhesive is applied directly over the security data. These security features may include security information (such as security information 120), markings (such as markings 140, including anti-counterfeiting and/or tamper-resistant/evident features), and/or other security features. For example, various processing may be performed on one or more of the layers of the security note to produce various optical effects that may serve as markings, aesthetic features, and/or security features. As just one example, a dielectric material may be printed on or otherwise deposited on a portion of the base layer. The dielectric material may have a thickness that is between 0.25 to 1.5 of a quarter wave thickness. The thickness may be selected to produce various colors when light is reflected off of the dielectric material.

In some embodiments, one or more markings may convey information associated with the security note, serve as aesthetic features, and/or provide security features. For example, the markings may indicate a source of the security note, a type of precious metal (if present) in the security note, a purity of precious metal (if present) in the security note, an amount of precious metal (if present) in the security note, a value of the security note, a serial number of the security note, and/or other information. In some embodiments, the markings may be applied by printing textual and/or image-based information on at least one of the substrates, intermediate base layers, base layers, adhesive layers, security layers, and/or other layers, holographically embossing at least one of the layers, and/or provided as separate layers. For example, in some embodiments, the substrate may be printed with one or more text-based and/or image-based markings. The printing may be done by applying a substance such as ink to the substrate and/or by indenting and/or embossing the markings onto the substrate. In some embodiments, the markings may be 3D printed onto the substrate. The markings may be applied prior to, during, and/or after the various layers are assembled. One or more of the markings may be of constant and/or variable thickens and/or may have different optical densities. In some embodiments, the security information may be provided between two opaque layers (such as the first and second base layers) so as to conceal sensitive information until the security note is delaminated, while some or all of the markings may be visible from an outside of the security note without delamination of the security note.

In embodiments in which one or more of the markings include a relief structure, the relief structure may be applied to a given layer using one or more techniques. For example, cavities of the relief structure may be created within a given layer's surface by heat application, melting, scratching, cutting, impacting, embossing, denting, blistering, surface relief casting, reticulation, bi-phase separation deposition, mud cracking, laser ablation, etching including plasma, laser, ion beam, electron beam, chemical, bead blasting, sand blasting, and/or other techniques. In embodiments in which multiple cavities are created, each cavity may be created the same or different technique. Protrusions of the relief structure may be created by placing pigmented ink, placing a transparent material, spraying material, printing material, placing material by adhesion, molding, painting, lamination, blistering, surface relief casting, reticulation, bi-phase separation, deposition, sintering, selective chemical vapor deposition, electroless plating, electroplating, low energy cauliflower growth deposition, and/or other deposition techniques. In embodiments in which multiple protrusions are created, each protrusion may be created the same or different technique.

At block 210, one or more openings or windows may be formed within one or both of the first base layer and the second base layer such that at least one of the one or more security features is visible via the opening. For example, one or more markings and/or other security features may be visible through the window without delaminating the security note as described above. The windows may be formed through one or more layers of material and may extend through all or only a portion of a thickness of the security note.

The windows may be formed prior to, during, and/or after application of a given layer of material of the security note. In some embodiments, the windows may be formed from removing material from an already-deposited layer. For example, portions of one or more already-applied layers may be feathered as described above, abraded, laser-etched, and/or otherwise removed to create a window. In some embodiments, a layer may be formed with a window prior to application to the security note, such as by die-cutting a metallic leaf or otherwise forming a pre-shaped layer prior to applying the layer to the security note. In some embodiments, a window may be formed by applying one or more layers in a manner in which a thin and/or blank area is formed, such as by using a masking agent (oil, ink, template of heat-resistant material, etc.) and/or selectively not applying any or a full thickness in one or more areas. In embodiments in which the window is only defined in interior layers (e.g., not defined by the outer substrate), the window may be formed prior to applying the outer substrate.

In some embodiments, such as those in which the markings convey information about the source, validity, or content of the laminate, a database may be maintained having the data associated with each laminate produced. For example, each laminate may be prepared with one or more markings. An electronic record of the markings of each laminate may be produced. For example, an identifier of each laminate, such as a serial number, may be associated with one or more other pieces of data of the respective laminate. For example, each serial number may be associated with a source of the laminate, a type of precious metal in the laminate, a purity of precious metal in the laminate an amount of precious metal in the laminate, a value of the laminate, and/or other information associated with a laminate. This record may be stored such that the information provided on a given laminate can be compared to the stored record to verify the authenticity of the laminate. In a particular example, the markings may include a public encryption key and the security information may include a private encryption key. The public key may be visible through a window in some embodiments. This may enable visual inspection of the public key ensures the public key matches the intended public key that was generated/assigned at time of inception of the private key. In some embodiments, the keys may be printed together. By printing the public key and private key together, it may be assured that the keys match up and eliminates the need to transmit the public key to another step of manufacture, thereby making the manufacturing process more secure. Additionally, by making the public key visible within the window and printing the public key and private key together on a single layer of the security note, it can be readily verified that the printing step occurred by checking that the public key is present without the need to delaminate the security note. In some embodiments, the private key may be printed in a wholly offline environment such that no data is saved on a network. The public key and any other associated security features may be viewed for verification, loading of bill, and/or checking of bill.

The methods, systems, and devices discussed above are examples. Some embodiments were described as processes depicted as flow diagrams or block diagrams. Although each may describe the operations as a sequential process, many of the operations can be performed in parallel or concurrently. In addition, the order of the operations may be rearranged. A process may have additional steps not included in the figure. It will be further appreciated that all testing methods described here may be based on the testing standards in use at the time of filing or those developed after filing.

It should be noted that the systems and devices discussed above are intended merely to be examples. It must be stressed that various embodiments may omit, substitute, or add various procedures or components as appropriate. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known structures and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of +20% or +10%, +5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of +20% or +10%, +5%, or +0.1% from the specified value, as such variations are appropriate to in the context of the systems, devices, circuits, methods, and other implementations described herein.

As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

What is claimed is:

1. A cryptographic note, comprising:
a first transparent substrate having an area that defines boundaries of the cryptographic note;
a first base layer deposited on the first transparent substrate;
a second base layer deposited on the first base layer; and
a second transparent substrate formed on the second base layer, wherein:
a private encryption key is provided between opaque portions of the first base layer and the second base layer;
the first base layer defines an opening within the area of the first transparent surface;
a public encryption key is provided within an interior of the cryptographic note and is visible via the opening;
the cryptographic note is configured to be de-laminated to irreversibly separate at least some layers of material of the cryptographic note to expose the private encryption key; and
the de-lamination causes irreversible damage to one or more layers of material on either side of the private encryption key.

2. The cryptographic note of claim 1, wherein:
the irreversible damage comprises at least one of:
turning one or both of the first base layer and the second base layer into flakes;
turning one or both of the first base layer and the second base layer into a powder;
folding the cryptographic note;
creasing the cryptographic note;
breaking of one or more print layers;
breaking of one or more security threads;
oxidation of one or more layers of the cryptographic note;
separation of one or more print layers into distinct surfaces of layers of the cryptographic note;
intentional tearing of one or more layers of the cryptographic note;
a color change of an adhesive layer; or
a de-metallization of a hologram.

3. The cryptographic note of claim 1, further comprising:
one or security features that enable an authenticity of the cryptographic note to be visibly verified.

4. The cryptographic note of claim 3, wherein:
the one or more security features comprise at least one of:
a hologram, color change ink, color change adhesive, a human readable feature, a computer readable feature, a code, a serial number, an information feature, a layer of gold having a thickness of less than about 200 nm, a relief structure, and a personal identification number (PIN).

5. The cryptographic note of claim 1, further comprising:
RF blocking layers disposed on both sides of the private encryption key.

6. The cryptographic note of claim 1, further comprising:
the first base layer and the second base layer form RF blocking layers disposed on both sides of the private encryption key.

7. The cryptographic note of claim 1, wherein:
one or both of the first base layer and the second base layer comprises a metal.

8. The cryptographic note of claim 7, wherein:
the metal comprises a precious metal.

9. The cryptographic note of claim 1, further comprising:
one or more markings that serve as identifying marks.

10. The cryptographic note of claim 9, wherein:
the one or more markings comprise at least one of trace quantities of a metal, embedded fibers, a dye coating, a spectral-shifting coating or treatment, particles having unique spectral properties, blind holes through a portion of a thickness of the cryptographic note, or microdamage elements.

11. A method of producing a cryptographic note, comprising:
depositing a first base layer on a first transparent substrate, the first transparent substrate having an area that defines boundaries of the cryptographic note;
depositing a second base layer on the first base layer;
applying a second transparent substrate to the second base layer; and
providing a private encryption key between opaque portions of the first base layer and the second base layer;
forming an opening within the first base layer; and
providing a public encryption key within an interior of the cryptographic note, wherein the public encryption key is visible via the opening, wherein:
the cryptographic note is configured to be de-laminated to irreversibly separate at least some layers of material of the cryptographic note to expose the private encryption key; and
the de-lamination causes irreversible damage to one or more layers of material on either side of the private encryption key.

12. The method of producing a cryptographic note of claim 11, wherein:
forming the opening comprises one or more of removing a portion of the first base layer, removing a portion of the second base layer, forming the opening by a deposition pattern of the first base layer, forming the opening by a deposition pattern of the second base layer, and using a masking procedure to define the opening.

13. The method of producing a cryptographic note of claim 11, wherein:
the opening extends beyond the public encryption key to expose one or more layers in which one or more tamper resistant markings are provided.

14. The method of producing a cryptographic note of claim 11, wherein:
the public encryption key and the private encryption key are printed at the same time.

15. The method of producing a cryptographic note of claim 11, wherein:
the public encryption key and the private encryption key are generated at the same time.

16. The method of producing a cryptographic note of claim 11, wherein:
the public encryption key and the private encryption key are assigned to the cryptographic note at the same time.

17. The method of producing a cryptographic note of claim 11, wherein:
the public encryption key and the private encryption key are provided on a same layer of the cryptographic note.

18. The method of producing a cryptographic note of claim 17, further comprising:
verifying that the public encryption key and the private encryption key have been printed without delaminating the cryptographic note.

19. The method of producing a cryptographic note of claim 11, wherein:
providing the private encryption key is done in a wholly offline environment 2 without any data being saved to a network.

20. The method of producing a cryptographic note of claim 11, further comprising:
providing a blocking layer on one or both sides of the private encryption key.
